(19) United States
(12) Patent Application Publication
(10) Pub. No.: US 2014/0137412 A1
(43) Pub. Date: May 22, 2014

(54) METHOD OF PRODUCING DOOR FRAME

(71) Applicant: SHIROKI CORPORATION, KANAGAWA (JP)

(72) Inventors: Makoto YAMADA, Kanagawa (JP); Jun MAKITA, Kanagawa (JP)

(73) Assignee: SHIROKI CORPORATION, KANAGAWA (JP)

(21) Appl. No.: 14/084,715

(22) Filed: Nov. 20, 2013

(30) Foreign Application Priority Data
Nov. 21, 2012 (JP) 2012-255480

(51) Int. Cl. B60J 5/04

(52) U.S. Cl. CPC B60J 5/0463
USPC 29/897.2

(57) ABSTRACT

A method of producing a door frame, which includes a tubular portion which is positioned on a vehicle interior side and has a closed cross-sectional shape, a design portion which is positioned on a vehicle exterior side, and a connecting portion which connects the tubular portion and the design portion; the method includes forming a frame body having a uniform cross section by roll-forming a metal sheet, the frame body including the tubular portion, the design portion and the connecting portion; and varying a width of the tubular portion by press-deforming a section of the tubular portion toward the vehicle interior side.

### BACKGROUND OF THE INVENTION

1. Field of the Invention

The present invention relates to a method of producing a door frame for a vehicle.

2. Description of Related Art

Door frames as components of vehicle doors which include a tubular portion that is positioned on the vehicle interior side, a design portion that is positioned on the vehicle exterior side and a connecting portion that connects the tubular portion and the design portion are known in the art. Although the strength of the door frame is secured by forming the tubular portion into a closed cross-sectional shape, it is sometimes the case that the tubular portion is made to vary in width (amount of projection toward the vehicle interior side) progressively for the purpose of, e.g., further enhancing the strength of part of the tubular portion. In the production of door frames, metal working processes such as roll-forming and press-forming are used; however, roll-forming is suitable for forming a door frame having a complicated shape into a shape having a uniform cross section, whereas it is difficult to form a door frame so that it progressively varies in width by roll-forming.

In Japanese Unexamined Patent Publication No. 2005-212646, to enhance the degree of flexibility in the shape of a side sash (rear side sash/upright-pillar sash) of a vehicle door frame, an outer panel and an inner panel are combined and formed into a shape that includes a tubular portion. The outer panel is formed by press-forming or roll-forming, the inner panel is formed by press-forming, and the cross sectional shape of the side sash progressively is made to vary progressively by changing the amount of projection of the inner panel toward the vehicle inner side.

The door frame disclosed in Japanese Unexamined Patent Publication No. 2005-212646 has a high degree of flexibility in regard to the determining of the cross sectional shape of the tubular portion; however, since this door frame is constructed from a combination of an outer panel and an inner panel, there is a problem with the number of components of the door frame being greater than that of a door frame which includes a tubular portion formed of a single plate by roll-forming. Additionally, in the door frame disclosed in Japanese Unexamined Patent Publication No. 2005-212646, the securement of strength of the joint between the outer panel and the inner panel needs to be taken into account.

### SUMMARY OF THE INVENTION

The present invention has been devised in view of the above problems and provides a method of producing a vehicle door frame which makes it possible to strike a balance between the level of strength and the level of flexibility in determining the shape.

According to an aspect of the present invention, a method of producing a door frame is provided which includes a tubular portion which is positioned on a vehicle interior side and has a closed cross-sectional shape, a design portion which is positioned on a vehicle exterior side, and a connecting portion which connects the tubular portion and the design portion, the method including forming a frame body having a uniform cross section by roll-forming a metal sheet, the frame body including the tubular portion, the design portion and the connecting portion; and varying a width of the tubular portion by press-deforming a section of the tubular portion toward the vehicle interior side.

It is desirable for the connecting portion to be formed from a pair of planar portions which extend toward the vehicle exterior side from the tubular portion and superpose each other. When varying the width of the tubular portion, one of the pair of planar portions slides toward the vehicle interior side so that the tubular portion increases in width. When roll-forming the frame body, an extension portion, which has a width corresponding to a sliding amount of the one of the pair of planar portions, is formed to project toward the vehicle exterior side to be continuous with the one of the pair of planar portions.

After the width of the tubular portion is varied, it is desirable for the extension portion that projects toward the vehicle exterior side beyond the design portion to be cut off.

Before the width of the tubular portion is varied in the section of the tubular portion, it is desirable for the pair of planar portions to be fixed to each other in a second section of the tubular portion in which width thereof is substantially constant. The pair of planar portions are fixed to each other after the width of the tubular portion is varied in the section of the tubular portion in which the width thereof has been varied.

When varying the width of the tubular portion, after a movable mold is inserted into the tubular portion, it is desirable for the movable mold to be slidably moved to press the tubular portion toward the vehicle interior side into a support mold.

After completion of the frame body, it is desirable for a second frame body which forms the design portion with the frame body to be fixed to the connecting portion.

According to the method of producing a door frame according to the present invention, forming the frame body having a uniform cross section by roll-forming and subsequently varying the width of the tubular portion by press-deforming a portion of the tubular portion, which is included in the frame body and has a closed cross-sectional shape, toward the vehicle interior side makes it possible to form the frame body out of a single member to thereby reduce the number of components of the door frame and to strike a balance between the level of strength of the door frame and the level of flexibility in determining the shape of the door frame.

The present disclosure relates to subject matter contained in Japanese Patent Application No. 2012-255480 (filed on Nov. 21, 2012) which is expressly incorporated herein by reference in its entirety.

### BRIEF DESCRIPTION OF THE DRAWINGS

The present invention will be discussed below in detail with reference to the accompanying drawings, in which:

FIG. 1 is a side elevational view of a motor-vehicle door (side door) according to the present invention;

FIG. 2 is a cross sectional view of the rear side sash of the door frame taken along the line II-II shown in FIG. 1;

FIG. 3 is a cross sectional view of the rear side sash of the door frame taken along the line III-III shown in FIG. 1;

FIG. 4 is a perspective view of the rear side sash, showing a production process thereof;

FIG. 5 is a cross sectional view of the rear side sash in the production process shown in FIG. 4;

FIG. 6 is a perspective view of the rear side sash, showing a production process thereof;

FIG. 7 is a cross sectional view of the rear side sash in the production process shown in FIG. 6;

FIG. 8 is a perspective view of the rear side sash, showing a production process thereof;

FIG. 9 is a cross sectional view of the rear side sash in the production process shown in FIG. 8;

FIG. 10 is a view corresponding to that of FIG. 2, showing the rear side sash of a door frame made according to a known production method; and

FIG. 11 is a view corresponding to that of FIG. 3, showing the rear side sash of a door frame made according to a known production method.

### DESCRIPTION OF THE EMBODIMENT

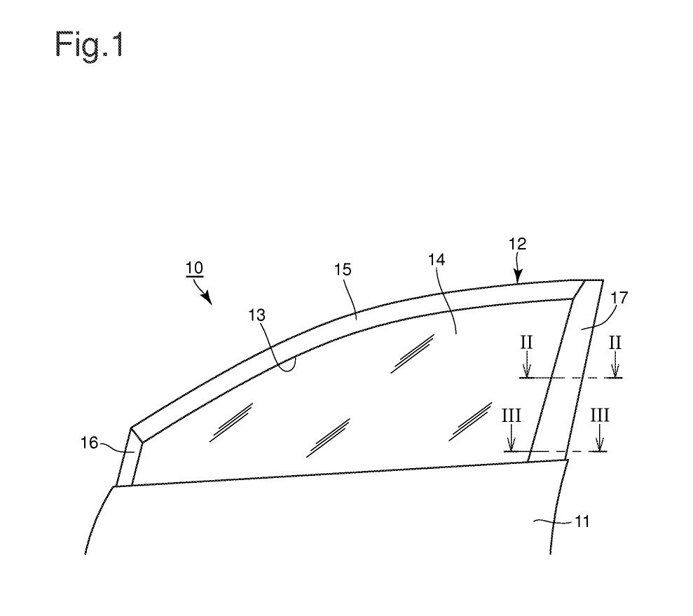

A motor-vehicle front door (hereinafter referred to simply as “door”) 10 shown in FIG. 1 is provided with a door panel 11 and a door frame 12. The region of the door 10 which is surrounded by the upper edge of the door panel 11 and the inner periphery of the door frame 12 is formed as a window opening 13. The door 10 is provided with a window pane 14 which moves up and down in the window opening 13. The door frame 12 is provided with an upper sash 15, a front side sash 16 and a rear side sash 17. The upper sash 15 forms the upper edge of the door 10, the front side sash 16 extends downward from the front end of the upper sash 15, and the rear side sash 17 extends downward from the rear end of the upper sash 15. The rear side sash 17 is joined to the upper sash 15 at a door corner (upper right corner with respect to FIG. 1). In the following description, the side of the door frame 12 adjacent to (facing) the window opening 13 is referred to as the inner peripheral side, and the opposite side of the door frame 12 from the inner peripheral side thereof is referred to as the outer peripheral side. Additionally, in a state where the door 10 is closed, the side of the door frame 12 which faces the vehicle interior is referred to as the vehicle interior side, and the opposite side of the door frame 12 from the vehicle interior side thereof is referred to as the vehicle exterior side.

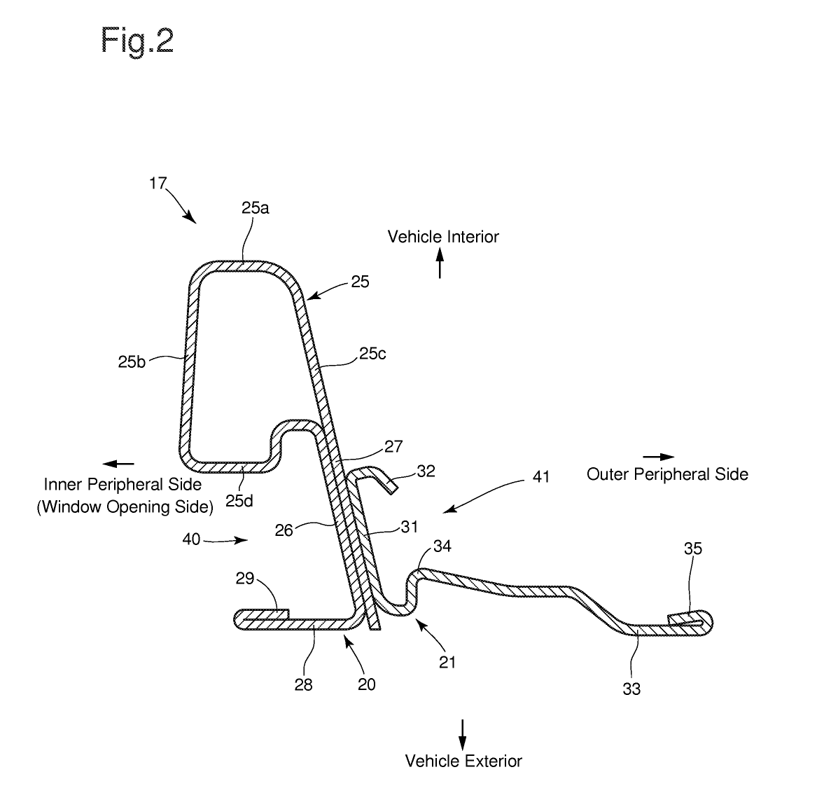

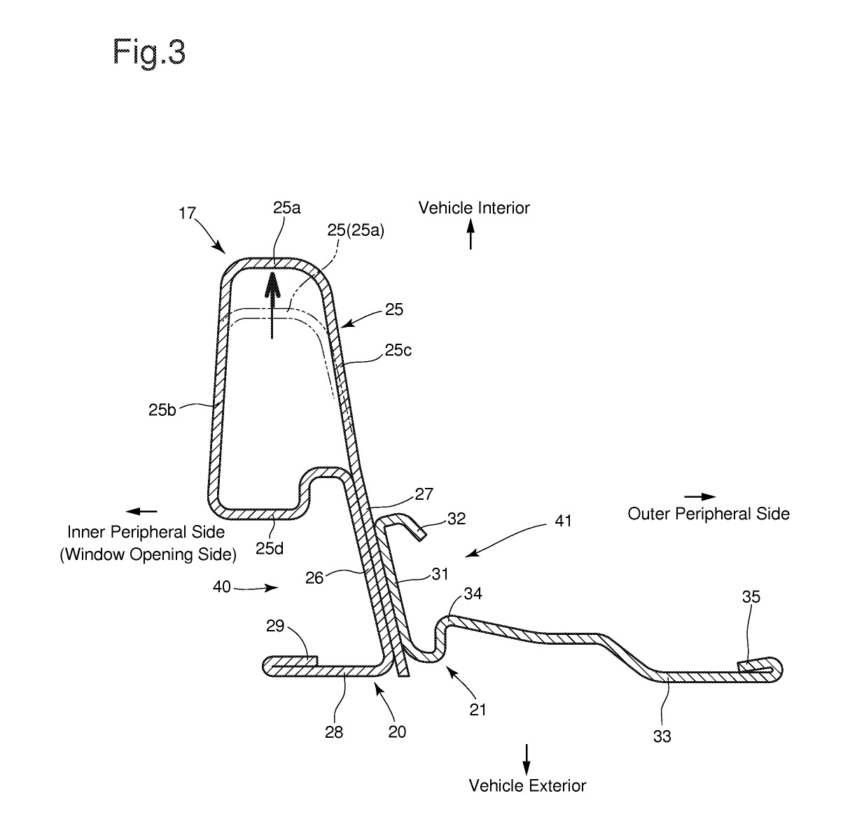

FIGS. 2 and 3 show the cross sectional shapes of the rear side sash 17 taken at different positions in the lengthwise direction thereof. FIG. 2 shows a general cross section of the major part of the rear side sash 17, and FIG. 3 shows a cross section of a lower part of the rear side sash 17 in the vicinity of the beltline (waistline) of the door 10 (i.e., in the vicinity of the upper edge of the door panel 11). As can be seen at either of these two cross-sectional positions, the rear side sash 17 includes an inner peripheral side member (frame body) 20 and an outer peripheral side member (second frame body) 21. Each of the inner peripheral side member 20 and the outer peripheral side member 21 is formed of a metal sheet by metal processing. As will be discussed later, the inner peripheral side member 20 is formed by a combination of roll-forming and press-forming. The outer peripheral side member 21 is formed by press-forming.

The inner peripheral side member 20 is provided with a tubular portion 25, a pair of connecting portions (planar portions) 26 and 27 and an inner peripheral side design portion 28. The tubular portion 25 is positioned on the vehicle interior side, the pair of connecting portions 26 and 27 are planar in shape and extend toward the vehicle exterior side and are parallel to each other from the tubular portion 25, and the inner peripheral side design portion 28 is formed by bending the vehicle exterior side end of the inner peripheral side connecting portion 26 toward the inner peripheral side of the door frame 12. The end (left end with respect to FIGS. 2 and 3) of the inner peripheral side design portion 28 is folded back toward the vehicle interior side to form an inner peripheral side hemmed portion 29.

The tubular portion 25 is provided with a vehicle interior side portion 25a, an inner peripheral side portion 25b, an outer peripheral side portion (planar portion) 25c and a vehicle exterior side portion 25d. The vehicle interior side portion 25a is positioned on the vehicle interior side. The inner peripheral side portion 25b and the outer peripheral side portion 25c extend toward the vehicle exterior side from both ends of the vehicle interior side portion 25a. The vehicle exterior side portion 25d is formed by bending a vehicle exterior side portion of the inner peripheral side portion 25b toward the outer peripheral side.

The tubular portion 25 has a closed cross sectional shape defining a hollow space enclosed by the vehicle interior side portion 25a, the inner peripheral side portion 25b, the outer peripheral side portion 25c and the vehicle exterior side portion 25d, with the vehicle interior side portion 25a and the vehicle exterior side portion 25d facing each other and with the inner peripheral side portion 25b and the outer peripheral side portion 25c facing each other. The vehicle exterior side portion 25d is formed to extend toward the outer peripheral side to a position to be in contact with the outer peripheral side portion 25c so as to form the vehicle exterior side portion of the tubular portion 25 into a closed shape. The outer peripheral side portion 25c is extended toward the vehicle exterior side to form the outer peripheral side connecting portion 27, and the inner peripheral side connecting portion 26 is formed by bending a portion of the tubular portion 25, which is continuous with the vehicle exterior side portion 25d, toward the vehicle interior side.

The tubular portion 25 is provided with a glass-guide portion (glass run retaining portion) 40 which is formed as a recessed portion surrounded by the tubular portion 25 (the vehicle exterior side portion 25d), the connecting portion 26 and the inner peripheral side design portion 28. A glass run (not shown) made of an elastic material is held in the glass-guide portion 40. The glass run has lips which sandwich both sides of an edge of a window pane, from the vehicle interior side and the vehicle exterior side to elastically hold this edge, when the window pane enters into the glass-guide portion 40.

The outer peripheral side member 21 is provided with a connecting portion 31, a holding lug 32 and an outer peripheral side design portion 33. The connecting portion 31 is fixed to the outer peripheral side of connecting portion 27 of the inner peripheral side member 20 to extend therealong, the holding lug 32 is formed by bending the vehicle interior side end of the connecting portion 31 into a substantially U-shape, in cross section, and the outer peripheral side design portion 33 is formed by bending the vehicle exterior side end of the connecting portion 31 toward the outer peripheral side of the door frame 12. The outer peripheral side design portion 33 is provided at an intermediate point in the widthwise direction thereof with a retaining protrusion 34 which protrudes toward the vehicle interior side and faces the holding lug 32. In addition, the outer peripheral side end of the outer peripheral side design portion 33 is folded back onto the vehicle interior side to form an outer peripheral side hemmed portion 35.

The outer peripheral side member 21 is provided with a weather strip retaining portion 41 which is defined by the connecting portion 31, the holding lug 32 and the outer peripheral side design portion 33 of the outer peripheral side member 21. A weather strip (not shown) is held in the glass-guide portion 40. This weather strip is provided with a leg portion, which is engaged with the holding lug 32 and the retaining protrusion 34 to be prevented from coming off, and a resilient contact portion which contacts an inner edge of the associated door opening of the vehicle body.

The inner peripheral side member 20 and the outer peripheral side member 21 are joined to each other by welding, with the connecting portions 27 and 31 overlaid on each other. In this fixed state, the inner peripheral side design portion and the outer peripheral side design portion 33 are substantially flush with each other to form a design portion (design surface) of the rear side sash 17. A garnish (automotive trim; not shown), which serves as an exterior member for covering the entire design portion extending from the inner peripheral side design portion 28 to the outer peripheral side design portion 33 from the vehicle exterior side, is fixed to this design portion of the rear side sash 17.

As shown in FIG. 1, the design portion of the rear side sash 17 progressively increases in width in the downward direction. This variation in width of the design portion of the rear side sash 17 is achieved by making the width of the outer peripheral side design portion 33 of the outer peripheral side member 21 vary progressively. As shown in FIGS. 2 and 3, the outer peripheral side design portion 33 is formed so that the cross section thereof at a lower position in the vicinity of the door panel 11 is greater in width than that at an upper position. In the outer peripheral side member 21 as a press-molded product, it is possible to make the width of the outer peripheral side design portion 33 vary progressively in the above described manner.

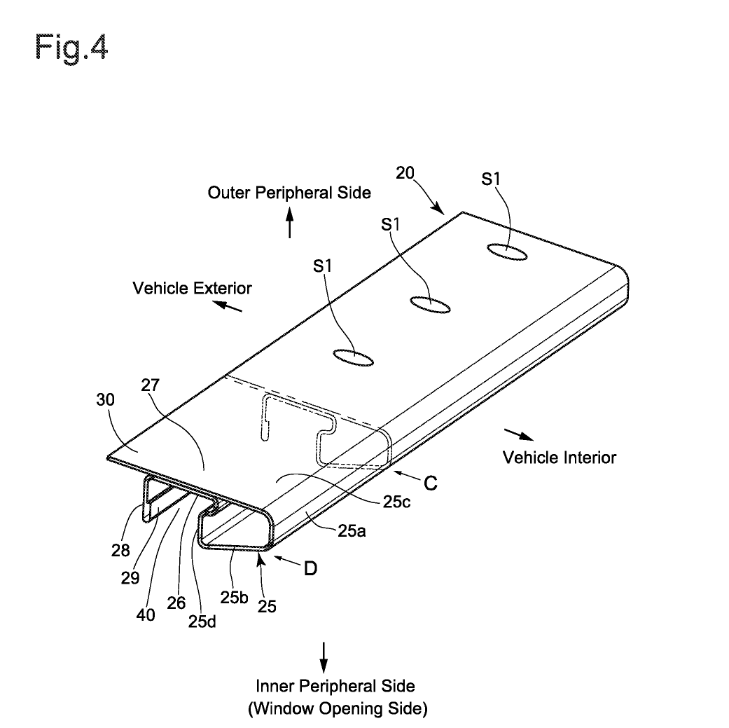

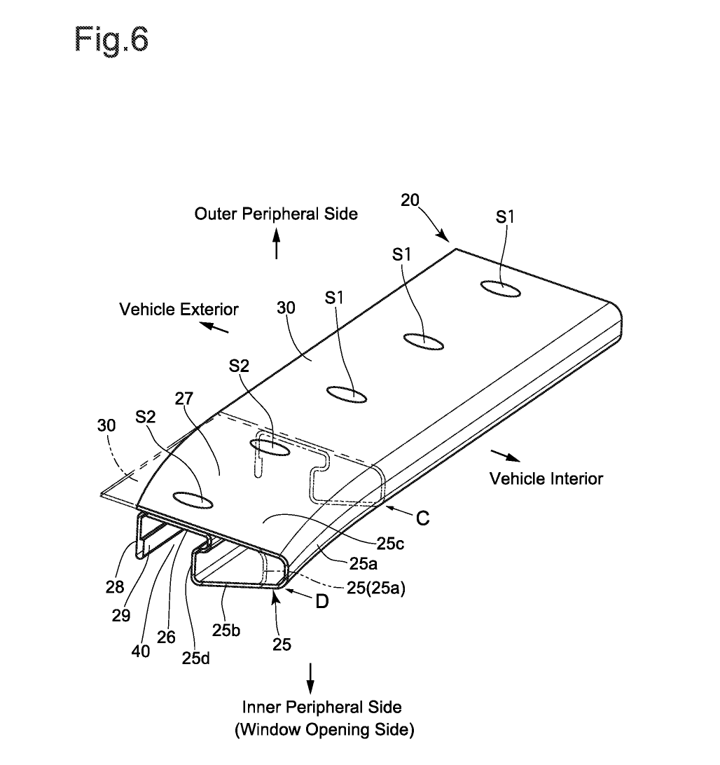

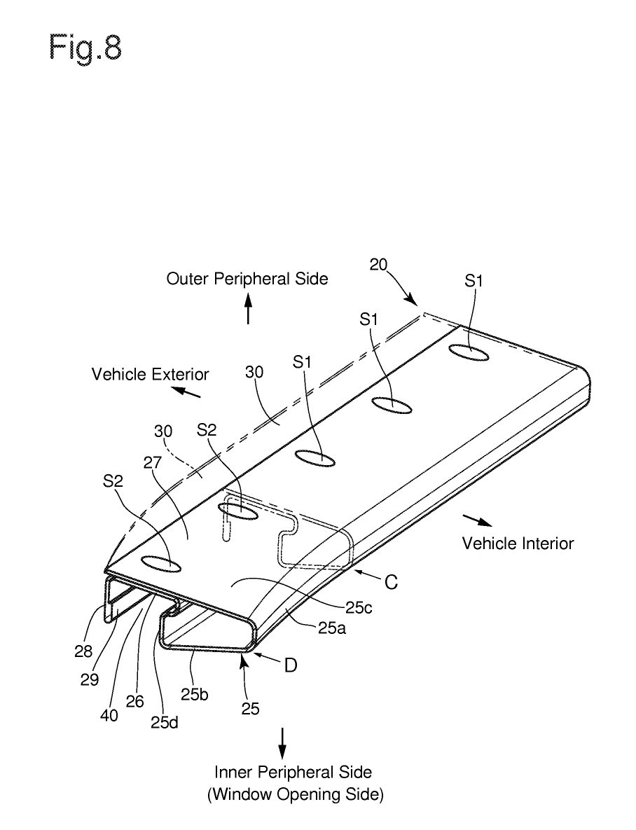

Additionally, in the rear side sash 17, the width of the tubular portion 25 (the amount of projection thereof toward the vehicle interior side) also varies. FIG. 2 shows a general cross section of the major part of the rear side sash 17 and FIG. 3 shows a cross section of a lower portion of the rear side sash 17, in the vicinity of the beltline of the door 10 as described above; the cross section of the rear side sash 17 at the position shown in FIG. 2 is made greater in width (amount of projection toward the vehicle interior side) than that at the position shown in FIG. 3. More specifically, the tubular portion 25 is constant in width in a general cross section of the major part of the rear side sash 17, while the tubular portion 25 progressively varies in width so that the amount of projection thereof toward the vehicle interior side progressively increases in the downward direction in a portion of the rear side sash 17 in the vicinity of the beltline. Point C shown in FIGS. 4, 6 and 8 designates the boundary between the constant width portion of the tubular portion 25 and the progressively width varying portion of the tubular portion 25; specifically, the tubular portion 25 progressively increases in width from the point C toward a point D as shown in FIGS. 6 and 8. The tubular portion 25 is constant in width from the point C upward. The strength of the part of the door panel 11 on the belt line is improved by progressively increasing the width of the tubular portion 25 from the point C to the point D. The inner peripheral side member 20 that has the above illustrated cross sectional shape is formed by the production method which will be discussed hereinafter.

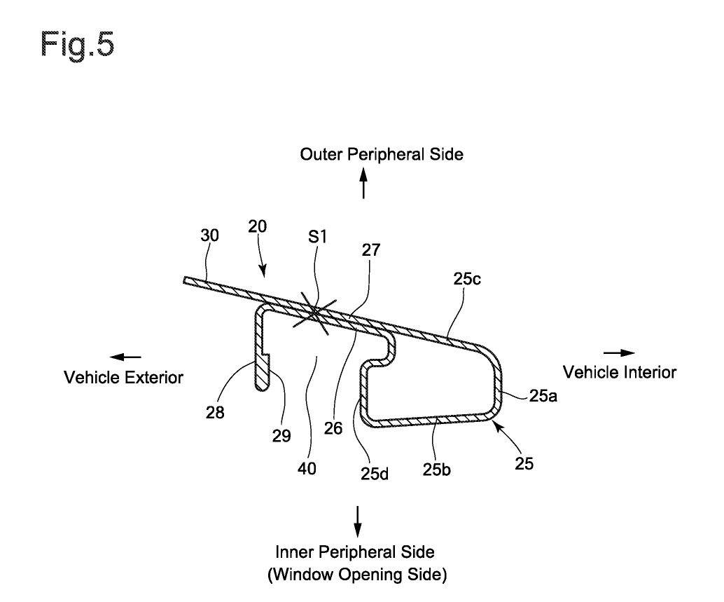

The inner peripheral side member 20 is firstly formed into a frame body that has a uniform cross-sectional shape, shown in FIGS. 4 and 5, by roll-forming. In this initially processed state, the tubular portion 25 has been formed to correspond to the cross sectional shape shown in FIG. 2, which has a small amount of projection toward the vehicle interior side. The tubular portion 25 is provided, on a planar portion thereof which is continuous with the connecting portion 27 from the outer peripheral side portion 25c, with an extension portion 30 which projects toward the vehicle exterior side beyond the position of the inner peripheral side design portion 28. At the stage upon the inner peripheral side member 20 having been formed by roll-forming, a seam welding process (“S1” in FIGS. 4 through 9 designate nuggets made by this process) is performed on the connecting portions 26 and 27 at predetermined intervals in the lengthwise direction of the rear side sash 17 to fix the connecting portions 26 and 27 to each other. The welding points of the seam-welded nuggets S1 are set within the uniform-width area of the tubular portion 25 (this area is positioned above the point C that is shown in FIGS. 4, 6 and 8). As for the area of the tubular portion 25 (which ranges from the point C to the point D that are shown in FIGS. 4, 6 and 8) on which a width widening operation in the subsequent process is performed, the connecting portions 26 and 27 are not fixed to each other by welding (or the like) at this stage.

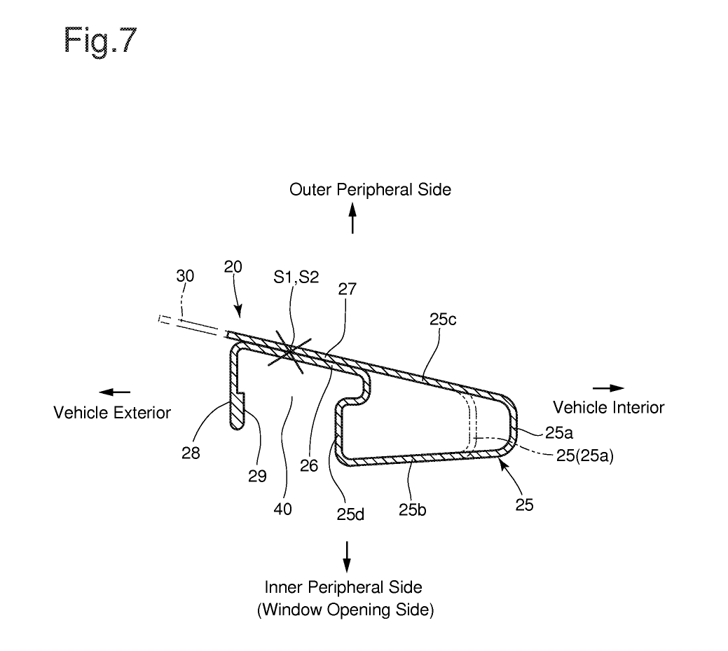

Subsequently, an operation for widening the width of the tubular portion 25 in the range from the point C to the point D is performed as shown in FIGS. 6 and 7. In FIGS. 6 and 7, the shapes of the tubular portion 25 before and after the width widening operation is performed thereon are shown by two-dot chain lines and solid lines, respectively. This operation is performed by press-forming; specifically, a movable mold (not shown) for pressing is inserted into the tubular portion 25, and the tubular portion 25 is press-deformed toward the vehicle interior side by pressing the movable mold. A support mold (not shown), which corresponds to the shape of the progressively width varying portion of the tubular portion 25 that is shown in FIGS. 6 through 8, is installed on the outside of the vehicle interior side portion 25a, the inner peripheral side portion 25b and the vehicle exterior side portion 25d; and the tubular portion 25 is press-formed by pressing the movable mold into the support mold. The vehicle exterior side portion 25d of the tubular portion 25, the connecting portion 26, the inner peripheral side design portion 28 are prevented from being deformed so as not be influenced by the pressing operation of the movable mold against the tubular portion 25.

When the tubular portion 25 is deformed to increase the width thereof, pressing the vehicle interior side portion 25a with the movable mold causes the position of the vehicle interior side portion 25a to be shifted toward the vehicle interior side while sliding the aforementioned planar portion of the tubular portion 25, which is continuous with the connecting portion 27 from the outer peripheral side portion 25c. As shown in FIGS. 6 and 7, the inner peripheral side portion 25b is also elongated toward the vehicle interior side in association with the displacement of the vehicle interior side portion 25a; however, this elongated portion of the inner peripheral side portion 25b has not been formed a result of stretching the inner peripheral side portion 25b in the initially processed state (shown in FIGS. 4 and 5), but rather has been formed by displacing and deforming the portion of the tubular portion 25 that formed the vehicle interior side portion 25a in the initially-process state. Likewise, the vehicle interior side portion 25a of the tubular portion 25, after it is deformed so as to increase the width thereof, has been formed by displacing and deforming the portion of the tubular portion 25 that initially formed the outer peripheral side portion 25c in the initially processed state. As a result, in the width-increased portion of the tubular portion 25, substantially the entire aforementioned planar portion of the tubular portion 25 that is continuous with the connecting portion 27 from the outer peripheral side portion 25c slides toward the vehicle interior side, so that the amount of projection of the extension portion 30 toward the vehicle exterior side becomes small. As described above, the tubular portion 25 is constant in width until an intermediate point of the rear side sash 17 (the point C shown in FIGS. 4, 6 and 8) and is made to vary in width progressively so that the amount of projection of the tubular portion 25 toward the vehicle interior side increases progressively in the downward direction from the point C in FIGS. 4, 6 and 8. In accordance with this variation of the width of the tubular portion 25, the amount of projection of the extension portion 30 toward the vehicle exterior side at the stage shown in FIGS. 6 and 7 progressively decreases in the downward direction from the point C. Additionally, at the point D at which the amount of projection of the tubular portion 25 toward the vehicle interior side has become maximum, the end of the connecting portion 27 is substantially coincident with the position of the inner peripheral side design portion 28, at which the extension portion 30 no longer projects toward the vehicle exterior side beyond the inner peripheral side design portion 28. In other words, the amount of projection of the extension portion 30 in the initially processed state shown in FIGS. 4 and 5 is set to correspond to the maximum sliding amount of the aforementioned planar portion of the tubular portion 25 that is required for the operation for widening the width of the tubular portion 25 toward the vehicle interior side. Hence, the width of the outer peripheral side portion 25c or the connecting portion 27 does not become insufficient even when the operation of widening the width of the connecting portion 25 is performed, and the width of the extension portion 30 which is removed in the subsequent process can be made minimum to increase the yield rate during manufacturing. After completion of the operation of widening the width of the tubular portion 25, in the range from the point C to the point D on which the width widening operation has been performed, a spot welding process (“S2” in FIGS. 6 through 9 designate nuggets made by this process) is performed on the connecting portions 26 and 27 at predetermined intervals in the lengthwise direction of the rear side sash 17 to fix the connecting portions 26 and 27 to each other.

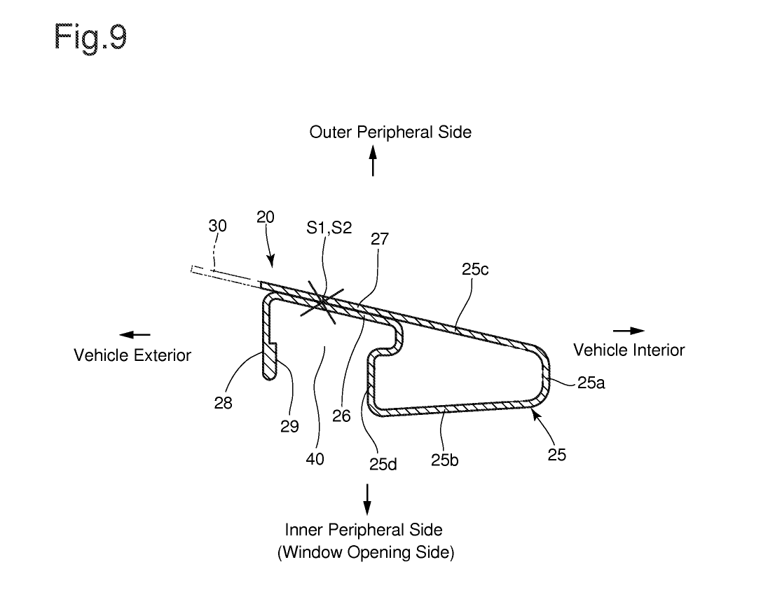

Lastly, the inner peripheral side portion 20 is completed by cutting off the extension portion 30, which projects toward the vehicle exterior side beyond the inner peripheral side design portion 28, as shown in FIGS. 8 and 9. The completed inner peripheral side portion 20 is provided with the tubular portion 25 which maintains the closed cross-sectional shape thereof across the rear side sash 17 in the lengthwise direction thereof; moreover, the width of the tubular portion 25 partly varies progressively. Two-dot chain lines in FIG. 3 show the shape of the tubular portion 25 (specifically the vehicle interior side portion 25a and the outer peripheral side portion 25c) before the width widening operation is performed thereon, and it can be seen that this shape of the tubular portion 25 changes to the shape shown by solid lines in FIG. 3 by performing a press-forming operation on the tubular portion 25 shown by the two-dot chain lines in FIG. 3. According to the door frame producing method of the present invention, the tubular portion that has a complicated shape by having a closed cross-sectional shape with the width thereof progressively changing can be made out of a single member as part of the inner peripheral side member 20.

As shown in FIGS. 2 and 3, the rear side sash 17 is completed by fixing the outer peripheral side member 21 to the outer peripheral side of the connecting portion 27 of the completed inner peripheral side member 20. Except for exterior parts (e.g., the aforementioned garnish), the aforementioned glass run and the aforementioned weather strip, the rear side sash 17 is configured of two members: the inner peripheral side member 20 and the outer peripheral side member 21.

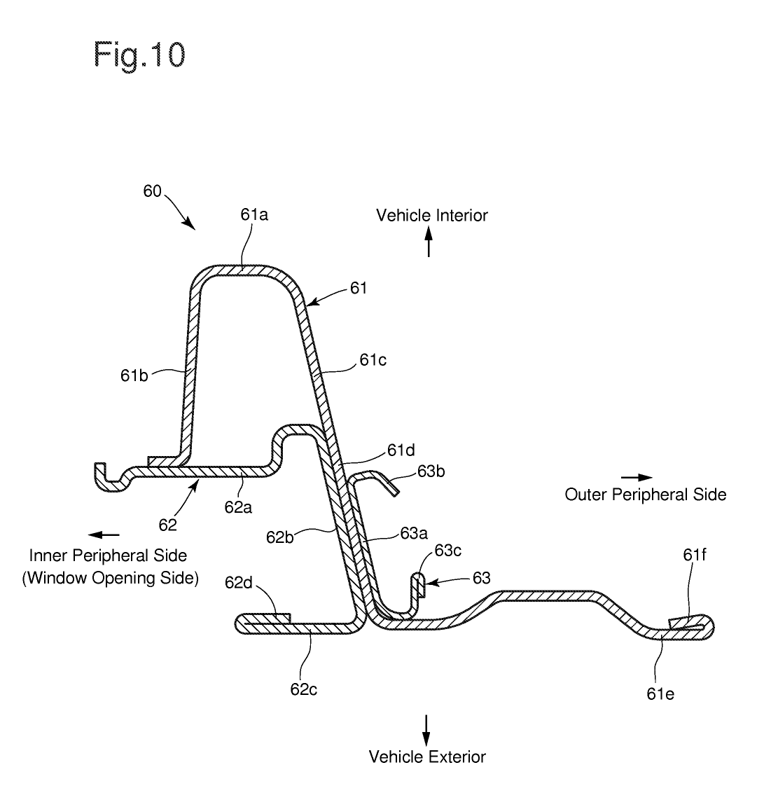

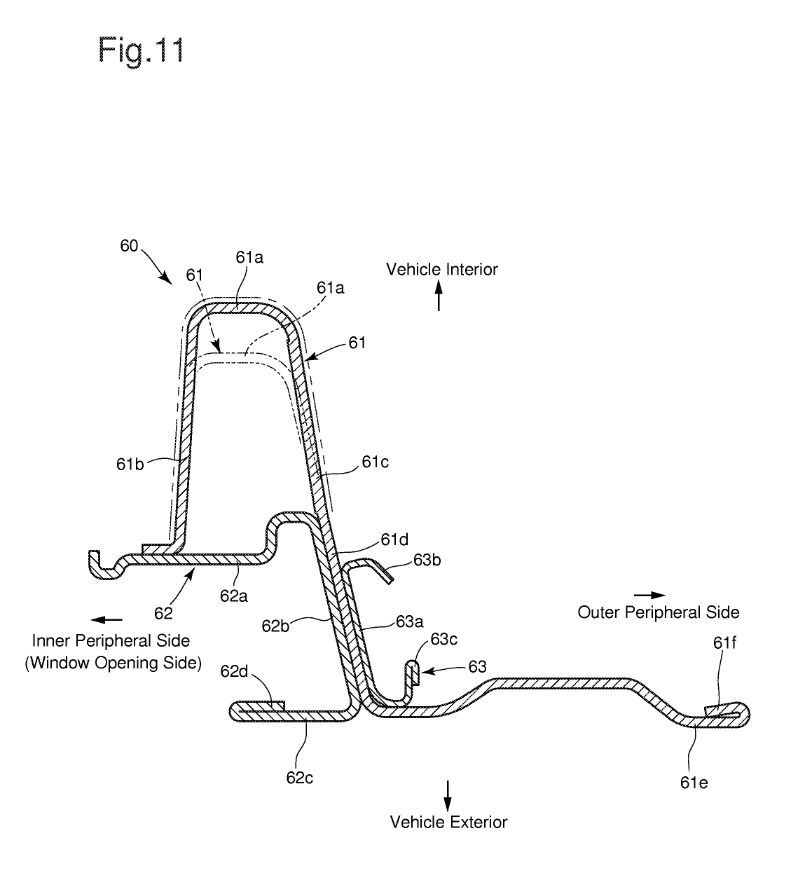

As an example to be compared with the rear side sash 17 of the above described embodiment of the door frame, a rear side sash of a door frame made according to a different door-frame producing method of the related art is shown in FIGS. 10 and 11. The rear side sash 60 of this comparative example is configured of three members: a main frame 61, a glass run retaining member 62 and a weather strip retaining member 63; the glass run retaining member 62 and the weather strip retaining member 63 are fixed to the main frame 61.

The main frame 61 is provided with a vehicle interior side portion 61a, an inner peripheral side portion 61b, an outer peripheral side portion 61c, a connecting portion 61d, an outer peripheral side design portion 61e, and an outer peripheral side hemmed portion 61f, which respectively correspond to the vehicle interior side portion 25a, the inner peripheral portion 25b, the outer peripheral side portion 25c and the connecting portion 27 of the tubular portion 25, and the outer peripheral side design portion 33 and the outer peripheral side hemmed portion 35 in the above described embodiment of the door frame. The main frame 61 is formed from a metal sheet by press-forming. The U-shaped cross-sectional portion of the main frame 61 which is surrounded by the vehicle interior side portion 61a, the inner peripheral portion 61b and the outer peripheral side portion 61c is formed into a width widening shape such that a portion of this U-shaped cross-sectional portion in the vicinity of the beltline which is shown in FIG. 11 projects toward the vehicle interior side beyond the position of the general cross section of the major part of the U-shaped cross-sectional portion of the main frame 61 shown in FIG. 10.

The glass run retaining member 62 is provided with a vehicle exterior side portion 62a, a connecting portion 62b, an inner peripheral side design portion 62c and an inner peripheral side hemmed portion 62d which correspond to the vehicle exterior side portion 25d, the connecting portion 26, the inner peripheral side design portion 28 and the inner peripheral side hemmed portion 29 of the tubular portion 25, respectively. The glass run retaining member 62 is formed from a metal sheet by roll-forming.

The weather strip retaining member 63 is provided with a connecting portion 63a, a holding lug 63b and a retaining protrusion 63c which correspond to the connecting portion 31, the holding lug 32 and the retaining protrusion 34 of the weather strip retaining portion 41 of the above described embodiment of the door frame, respectively. The weather strip retaining member 63 is formed from a metal sheet by roll-forming. The glass run retaining member 62 and the weather strip retaining member 63 are uniform in cross sectional shape along the entirety of the rear side sash 60 in the lengthwise direction thereof.

In the rear side sash 60, the vehicle interior side portion 61a, the inner peripheral portion 61b and the outer peripheral side portion 61c of the main frame 61 form a U-shaped cross-sectional portion, and the vehicle exterior side portion 62a of the glass run retaining member 62 covers the opening of this U-shaped cross-sectional portion to complete the tubular portion of the rear side sash 60 that has a closed cross-sectional shape. Accordingly, two members, i.e., the main frame 61 and the glass run retaining member 62, are required to form the tubular portion of the rear side sash 60 that progressively varies in width, so that the rear side sash 60 is configured of a greater number of elements than the rear side sash 17 that includes the inner peripheral side member 20 that is formed according to the present invention. Additionally, in the rear side sash 60, the shape and joint strength of the joint between the inner peripheral portion 61b of the main frame 61 and the vehicle exterior side portion 62a of the glass run retaining member 62 needs to be taken into account, so that control of the formed parts during manufacturing becomes more complicated than that of the above described embodiment of the door frame according to the present invention, in which the inner peripheral side member 20 is made of a single member.

As can be clearly understood from the above descriptions, with application of the method of producing a door frame according to the present invention, it is possible to make the inner peripheral side member 20, which includes the cylindrical member 25, out of a single member to achieve a reduction of the number of components of the door frame and to strike a balance between the level of strength of the door frame 12 and the level of flexibility in the shape setting of the door frame 12.

Although the present invention has been described based on the above illustrated embodiment, the present invention is not limited solely thereto; various modifications to the above illustrated embodiment are possible. For instance, although the present invention has been applied to the rear side sash 17 of the door frame 12 in the above described embodiment, the present invention can also be applied to the production of other parts than the rear side sash 17 of the door frame 12. In addition, although the above illustrated embodiment of the door frame is an example of the application of the present invention to a motor-vehicle front door, the present invention can also be applied to the production of door frames other than front doors.

Although the tubular portion 25 of the rear side sash 17 progressively increases in width in the direction from the point C toward the point D as shown in FIGS. 4, 6 and 8 in the above illustrated embodiment, the present invention can also be applied to a type of door frame in which the tubular portion thereof which corresponds to the tubular portion 25 does not have a shape which progressively varies in width in one direction in such a manner. For instance, the present invention can also be applied to a door frame having a shape such that the tubular portion 25 progressively increases in width from the point C to a point part way to the point D and subsequently remains constant or decreases in width from this point until the point D, or a shape such that the tubular portion 25 progressively increases in width from the point C to a point part way to the point D, subsequently remains constant from this point to another point partway to the point D and thereafter decreases in width from this another point until the point D.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A method of producing a door frame which includes a tubular portion which is positioned on a vehicle interior side and has a closed cross-sectional shape, a design portion which is positioned on a vehicle exterior side, and a connecting portion which connects said tubular portion and said design portion, said method comprising:
forming a frame body having a uniform cross section by roll-forming a metal sheet, said frame body including said tubular portion, said design portion and said connecting portion; and
varying a width of said tubular portion by press-deforming a section of said tubular portion toward said vehicle interior side.

2. The method of producing a door frame according to claim 1, wherein said connecting portion is formed from a pair of planar portions which extend toward said vehicle exterior side from said tubular portion and superpose each other,
wherein, when varying said width of said tubular portion, one of said pair of planar portions slides toward said vehicle interior side so that said tubular portion increases in width, and
wherein, when roll-forming said frame body, an extension portion, which has a width corresponding to a sliding amount of said one of said pair of planar portions, is formed to project toward said vehicle exterior side to be continuous with said one of said pair of planar portions.

3. The method of producing a door frame according to claim 2, wherein, after said width of said tubular portion is varied, said extension portion that projects toward said vehicle exterior side beyond said design portion is cut off.

4. The method of producing a door frame according to claim 2, wherein, before said width of said tubular portion is varied in said section of said tubular portion, said pair of planar portions are fixed to each other in a second section of said tubular portion in which width thereof is substantially constant, and
wherein said pair of planar portions are fixed to each other after said width of said tubular portion is varied in said section of said tubular portion in which the width thereof has been varied.

5. The method of producing a door frame according to claim 1, wherein, when varying said width of said tubular portion, after a movable mold is inserted into said tubular portion, said movable mold is slidably moved to press said tubular portion toward said vehicle interior side into a support mold.

6. The method of producing a door frame according to claim 1, wherein, after completion of said frame body, a second frame body which forms said design portion with said frame body is fixed to said connecting portion.
